(19) United States
(12) Patent Application Publication
(10) Pub. No.: US 2007/0246371 A1
(43) Pub. Date: Oct. 25, 2007

(54) Method for removing diamond-like carbon film from a substrate

(75) Inventor: Bor-Yuan Hsiao, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,907

(22) Filed: Oct. 26, 2006

(30) Foreign Application Priority Data
Apr. 19, 2006 (CN) 200610060393.0

(51) Int. Cl. B23H 3/00

(52) U.S. Cl. 205/640

(57) ABSTRACT

A method for removing a diamond-like carbon film on a substrate is provided. The diamond-like carbon film includes an amorphous carbon layer and an amorphous hydrogenated carbon layer formed on the amorphous hydrogen-free carbon layer. The method includes a step of electrolyzing the diamond-like carbon film in an acid solution. Compared with grinding, the electrolyzing process has advantages of low cost being cheaper, more convenient and results in a smoother surface.

### TECHNICAL FIELD

The present invention relates to a method for removing a diamond-like carbon film from a substrate.

### DISCUSSION OF RELATED ART

Amorphous carbon (a-C) and hydrogenated amorphous carbon (a-C:H) films have desirable properties such as hardness, low friction, electrical insulation, chemical inertness, optical transparency, biological compatibility, selective photon absorption, smoothness, etc. For a number of years, these economically and technologically attractive properties have drawn almost unparalleled interest towards these coatings. Carbon films which are very hard, and which have high resistivity, and good dielectric optical properties, are now described as diamond-like carbon (DLC).

In order to improve adhesion between a DLC film and a substrate, an intermediate film is usually formed between the DLC film and the substrate. The intermediate film can be selected from the group consisting of chromium film, chromium nitride, chromium carbide and any combination thereof. Compared with amorphous hydrogenated carbon, amorphous carbon has better adhesion with the intermediate film, but amorphous hydrogenated carbon has better wear resistance and a lower friction coefficient, thus a DLC film usually includes an amorphous carbon layer formed on the intermediate film and an amorphous hydrogenated carbon layer formed on the amorphous carbon layer.

Although the DLC film has good wear resistance, but after a long time period the DLC film may be worn away. In another case the DLC film may have a quality problem such as uneven film thickness. In these cases, the flawed DLC film must be removed and a new DLC film can be formed. Grinding is a useful process for removing the flawed DLC film. However, grinding has poor precision. Plasma bombardment can also be used for removing a DLC film formed on a substrate, but is very expensive.

Therefore, there is a desire to proving a method for removing a DLC film from a substrate, which is cheap, and can be conducted with a high level of precision.

### SUMMARY

In one embodiment, a method for removing a diamond-like carbon film from a substrate is provided. The diamond-like carbon film includes an amorphous hydrogen-free diamond-like carbon layer and an amorphous hydrogenated diamond-like carbon layer formed on the amorphous hydrogen-free carbon layer. The method includes a step of electrolyzing the amorphous hydrogen-free diamond-like carbon layer in an acid solution thereby removing the diamond-like carbon film from the substrate.

This and other features and advantages of the present invention as well as the preferred embodiments thereof in accordance with the invention will become apparent from the following detailed description and drawings.

### BRIEF DESCRIPTION OF THE DRAWINGS

Many aspects of the present method for removing a DLC film on a substrate can be better understood with reference to the following drawings. The components in the drawings are not necessarily drawn to scale, the emphasis instead being placed upon clearly illustrating the principles of the present invention.

FIG. 1 is a schematic view of a substrate having a diamond-like carbon film to be removed;

FIG. 2 is a flow chart in accordance with an embodiment of a method for removing the diamond-like carbon film of FIG. 1; and

FIG. 3 is schematic view of a vacuum chamber for removing a diamond-like carbon film.

### DETAILED DESCRIPTION OF THE PREFERRED EMBODIMENTS

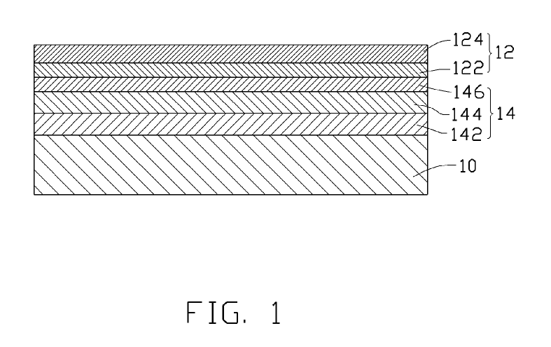

Referring to FIG. 1, a DLC film 12 formed on a substrate 10 is shown. An intermediate film 14 is formed between the DLC film 12 and the substrate 10. The DLC film includes an amorphous carbon layer 122 formed on the intermediate film 14 and an amorphous hydrogenated carbon layer 124 formed on the amorphous carbon layer 122. The intermediate film 14 improves an adhesion between the DLC film 12 and the substrate 10. The intermediate film 14 can be selected from the group consisting of chromium film, chromium nitride, chromium carbide and any combination thereof. In the preferred embodiment, the intermediate film 14 includes a chromium film 142 formed on the substrate 10, a chromium nitride film 144 formed on the chromium and a chromium carbide film 146 formed on the chromium nitride film 144.

A method for removing the DLC film 12 on the substrate 10 in accordance with a first embodiment includes the step of electrolyzing the DLC film 12 in an acid solution until the DLC film 12 peels from the intermediate film 14. Because amorphous carbon has a number of free electrons, the amorphous carbon layer 122 is conductive. The amorphous carbon layer 122 can act as an anode in the process of the electrolyzing and is oxidized into carbon oxide.

The acid solution can be prepared from sulfur acid, hydrochloric acid and mixture thereof. Preferably, the pH value of the acid solution is in the approximate range from 1 to 3. Electrolyzing voltage should be higher than 2 volts. Preferably, the operation volt is in the approximate range from 2 volts to 100 volts. An operation current of the electrolyzing is higher than 0.1 amperes. Preferably, the operation current is in the approximate range from 0.1 amperes to 10 amperes. Preferably, the electrolyzing step is performed for a time period in the approximate range from 1 minute to 10 minutes.

In the preferred embodiment, the DLC film is removed by using electrolysis. Compared with grinding, electrolysis is cheap, convenient and results in a higher level of smoothness.

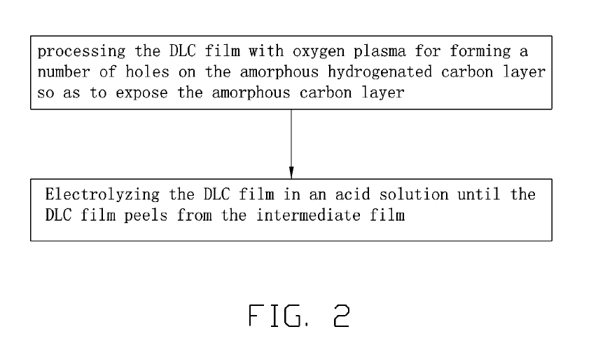

Referring to FIG. 2, a method for removing the DLC film 12 on the substrate 10 includes the steps of:

### Step 1, bombarding the DLC film 12 with oxygen plasma to form a number of holes on the amorphous hydrogenated carbon layer 124 thereby exposing the amorphous carbon layer 122; and

### Step 2, electrolyzing the DLC film 12 in an acid solution until the DLC film 12 peels off from the intermediate film 14.

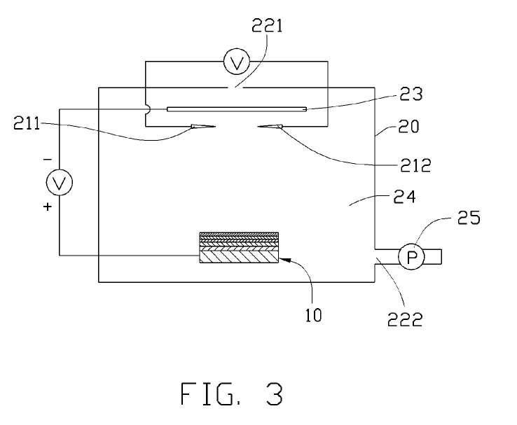

In step 1, preferably, the DLC film 12 is processed with oxygen plasma in a vacuum environment, for example, in a vacuum chamber. Referring to FIG. 3, a vacuum reactor 20 defines a vacuum chamber 24 therein. The vacuum reactor 20 also defines an inlet 221 configured (i.e., structured and arranged) for supplying oxygen and an outlet 222. A first discharge electrode 211 and a second discharge electrode 212 are disposed in the vacuum chamber 24 and are spaced a distance from each other. The substrate 10 is disposed in the vacuum chamber 24 away from the first discharge electrode 211 and the second discharge electrode 212. A bias electrode 23 is disposed adjacent to the first discharge electrode 211 and the second discharge electrode. The bias electrode 23 is electrically connected with the substrate 10. A bias voltage is applied between the substrate 10 and the bias electrode 23. A vacuum pump 25 is connected with the outlet 222 and is configured for depresurizing the vacuum chamber 24.

A voltage is applied between the first discharge electrode 211 and the second discharge electrode 212. When discharge occurs between the first discharge electrode 211 and the second discharge electrode 212, a number of free electrons are released. These free electrons bombard the oxygen atoms and ionize them thereby producing an oxygen plasma. The oxygen plasma includes oxygen atoms, free electrons, oxygen ions, oxygen cations, etc. The oxygen cations are accelerated by the oxygen cations and bombard the DLC film 12 on the substrate 10.

The accelerated oxygen cations have high reactivity and high energy. After being bombarded by the oxygen cations, chemical bonds between carbon atoms and hydrogen atoms are cut thus weakening or destroying the DLC film 12. In other words, the DLC film 12 reacts with the oxygen cations and is oxidated to form carbon oxide and water, a number of holes are formed on the amorphous hydrogenated carbon layer 124 thus exposing the amorphous carbon layer 122.

In step 2, the DLC film 12 is electrolyzed in an acid solution. Because the amorphous carbon layer 122 is exposed to the acid solution, the electrolyzing process is accelerated.

The acid solution can be selected from the group consisting of sulfur acid, hydrochloric acid and a mixture of the two. Preferably, the pH value of the acid solution is in the approximate range from about 1 to about 3. An electrolysis voltage should be higher than 2 volts. Preferably, the operation volt is in the approximate range from 2 volts to 100 volts. An operation current of the electrolyzing is higher than 0.1 amperes. Preferably, the operational current is in the approximate range from 0.1 amperes to 10 amperes. Preferably, the electrolyzing step is performed for a time period in the approximate range from 1 minute to 10 minutes.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A method for removing a diamond-like carbon film on a substrate, the diamond-like carbon film comprising an amorphous hydrogen-free carbon layer and an amorphous hydrogenated carbon layer formed on the amorphous hydrogen-free carbon layer, the method comprising a step of electrolyzing amorphous hydrogen-free carbon layer of the diamond-like carbon film in an acid solution thereby removing the diamond-like carbon film from the substrate.

2. The method as claimed in claim 1, wherein the diamond-like carbon film is treated with an oxygen plasma bombardment prior to the electrolyzing step.

3. The method as claimed in claim 2, wherein the oxygen plasma bombardment is performed in a vacuum chamber.

4. The method as claimed in claim 1, wherein the acid solution can be selected from the group consisting of hydrochloric acid, sulfur acid and mixture thereof.

5. The method as claimed in claim 1, wherein a pH value of the acid solution is in the approximate range from about 1 to about 3.

6. The method as claimed in claim 1, wherein the electrolyzing step is performed for a time period in the approximate range from 1 minute to 10 minutes.

7. The method as claimed in claim 1, wherein the electrolyzing step is performed with a current in the approximate range from 0.1 amperes to 10 amperes.

8. The method as claimed in claim 1, wherein the electrolyzing step is performed at a voltage in the approximate range from 2 volts to 100 volts.

9. A method for removing an amorphous hydrogenated diamond-like carbon film on a substrate, the method comprising a step of electrolyzing the amorphous hydrogenated diamond-like carbon film in an acid solution.

10. The method as claimed in claim 9, wherein a pH value of the acid solution is in the approximate range from about 1 to about 3.

11. The method as claimed in claim 9, wherein the electrolyzing step is performed for a time period in the approximate range from 1 minute to 10 minutes.

12. The method as claimed in claim 9, wherein the electrolyzing step is performed with a current in the approximate range from 0.1 amperes to 10 amperes.

13. The method as claimed in claim 9, wherein the electrolyzing step is performed at a voltage in the approximate range from 2 volts to 100 volts.
